(19) United States
(12) Patent Application Publication
(10) Pub. No.: US 2023/0064321 A1
(43) Pub. Date: Mar. 2, 2023

(54) MAGNETIC COMPONENT WITH ELASTIC MAGNETIC COMPOUND

(71) Applicant: Max Baerman Gesellschaft mit Beschränkter Haftung, Bergisch Gladbach (DE)

(72) Inventor: Patrick Kuntschke, Köln (DE)

(21) Appl. No.: 17/795,493

(22) PCT Filed: Jan. 28, 2021
(86) PCT No.: PCT/EP2021/052007

§ 371 Date: Jul. 26, 2022

(30) Foreign Application Priority Data
Jan. 30, 2020 (EP) 20154692.6

(51) Int. Cl. H01F 41/02; H02K 1/02; H01F 1/26

(52) U.S. Cl. CPC H01F 41/0246; H01F 1/26; H02K 1/02

(57) ABSTRACT

A magnetic component (100) includes a main body (1) made of a main body material and a magnetic plastic part (2) connected in a fixed position to the main body (1). The plastic part (2) is produced from a compound which includes a polymeric support material and magnetic particles embedded in the polymeric support material, and the main body material and the compound having different thermal expansion characteristics. The plastic part (2) has a contact surface by which it is connected in a fixed position to the main body (1), and at least 60% by weight, in particular between 60% by weight and 95% by weight of the compound consists of the magnetic particles and the compound is formed as an elastic material for preventing cracks from forming in the magnetic plastic part (2), in particular the main body material being metal and the main body (1) in particular in the manner of a sleeve, disc or shaft

The invention relates to a magnetic component according to the generic part of claim 1 and to the use of a main body, magnetic particles and a polymer powder to achieve a magnetic component.

Generic magnetic components are typically used to attach a magnet, in particular a permanent magnet, to a rotating component so that this magnet can be used as a motor or sensor magnet. It is known to realize a magnetic component for this purpose, which comprises a magnetic plastic part and a main body. The magnetic plastic part usually comprises magnetic, in particular hard magnetic particles, embedded in a polymeric support material. Such plastic parts in which material particles are embedded in a polymeric support material or polymer matrix are usually referred to as highly filled plastic parts. If such plastic parts contain a high filling level of magnetic particles, they are often referred to as plastic-bonded permanent magnets. Magnetic particles, in particular hard magnetic particles, are particles from at least one material that is magnetizable or already magnetized due to its magnetic properties.

In principle, conventional magnetic components have proven to be particularly suitable in many respects for attaching a magnet to a rotating component, such as a shaft or sleeve. While the plastic part, which is usually annular, in particular hollow cylindrical, over at least 50%, in particular over at least 70%, in particular over its entire extent, provides the magnet, the main body serves to fix the magnetic component to the component to be rotated in a rotationally fixed manner. For this purpose, the main body is usually designed in the form of a sleeve or shaft and can be press-fitted onto a corresponding component to be rotated, such as a shaft or sleeve, and thus mounted. The magnetic plastic part is usually connected to the main body in a positionally fixed manner so that, when the magnetic component is used as intended, the plastic part follows any change in position of the main body, in particular when the main body is rotated about an axis of rotation assigned to it, which, when the magnetic component is used as intended, corresponds to the axis about which the component to be rotated is rotated when the magnetic component is mounted to it, so that conclusions can be drawn about the rotation of the component to be rotated to which the magnetic component is attached by detecting the magnetic field generated by the magnetic plastic part. Usually, the plastic part has a smaller extension in a direction along which the axis associated with the main body runs than perpendicular to this direction, the smaller extension being in particular less than 70%, in particular less than 50%, in particular less than 35% of the extension of the plastic part perpendicular to this direction, which can entail the greatest possible saving of material while maintaining sufficient magnetic properties. Of course, the magnetic component is usually connected to the component to be rotated in a rotationally fixed manner, in particular exclusively, by means of the main body, so that a specific rotational position of the magnetic component can be associated with a specific rotational position of the component to be rotated about said axis. The invention further relates to an arrangement comprising the component to be rotated and the magnetic component, wherein the magnetic component is non-rotatably connected to the component to be rotated, in particular exclusively, by means of the main body.

However, various problems arise in the implementation of a suitable generic magnetic component. First, the main body is usually made of a different material than the plastic part, since the main body and the magnetic plastic part must each have different properties. The main body is intended to provide a reliable, non-rotating fixation to a component to be rotated, whereas the magnetic plastic part must serve the purpose of providing a magnet, in particular a permanent magnet, with a clearly predetermined magnetic field that is specifically adjusted to the particular application. Accordingly, the thermal expansion behavior of the main body usually differs from the thermal expansion behavior of the magnetic plastic part, and usually the main body is made of a much harder material than the magnetic plastic part. The magnetic plastic part, on the other hand, must be manufactured in such a way that the magnetic particles are contained in the plastic part as uniformly as possible and with a sufficiently high density, and the plastic part can be injection-molded to the main body in a manner as simple and predeterminable as possible.

These requirements placed on generic magnetic components make it difficult to manufacture a robust magnetic component that can be used over the long term. Because of the different material properties of the main body material and the material of the magnetic plastic part and their different thermal expansion behavior, cracks often form in the magnetic plastic part, since the different thermal expansion behavior leads to stresses in the plastic part when the plastic part is connected to the main body in a position fixed manner. In particular, it must be taken into account that generic magnetic components are typically used in environments in which considerable temperature fluctuations occur, in particular from -10° C. to +100° C., in particular -30° C. to +120° C., in particular -40° C. to 125° C., in particular -40° C. to +150° C. In addition, in use, in particular in use in a motor vehicle, such magnetic components must withstand temperature fluctuations in the temperature range mentioned above over many cycles, in particular several hundred cycles, in particular over a thousand cycles. These problems have been countered in the prior art, for example, by providing an elastic intermediate layer between the main body and the magnetic plastic part, via which the magnetic plastic part is bonded to the main body. However, this has proved costly, and the implementation of such a magnetic component requires very precise adherence to process steps, which causes defects in the manufacture of such magnetic components. Alternatively, attempts have been made to match the material of the magnetic plastic part in its thermal expansion behavior as closely as possible to the thermal expansion behavior of the main body. However, this is accompanied by quality losses with respect to the robustness of the material of the magnetic plastic part or with respect to the material of the main body and its attachability to a component to be rotated.

The present invention is based on the problem of providing a magnetic component and/or a method for implementing a magnetic component, with which at least some of the disadvantages of conventional magnetic components or methods can be at least partially overcome.

As a solution to said technical problem, the invention proposes a magnetic component comprising a main body made of a main body material and a magnetic plastic part connected to the main body in a positionally fixed manner. The magnetic plastic part is made of a compound. The compound is prepared via compounding commonly used in plastics technology, in which commercially available machines provided for this purpose, such as single-shaft extruders, twin-shaft extruders, co-kneaders or dispersion kneaders, are used. The prepared compound is fed to a processing plant, for example an injection molding plant, in which the magnetic plastic part is produced, for example by means of injection molding. According to the invention, the compound has a polymeric base material and magnetic particles embedded in the polymeric support material. In particular, the main body material and the compound from which the magnetic plastic part is made have different thermal expansion behaviors. Thus, in particular, the main body material and the compound exhibit a different dependence of their respective volumes on temperature, in particular within a temperature range of 0° C. to 100° C. The different thermal expansion behavior is due to the fact that the main body material is not identical to the compound, since the main body serves different purposes than the compound. The purpose of the main body is to enable the magnet component to be fixed as robustly and firmly as possible to a component to be rotated, which is why the main body material preferably has a high tensile strength and, in particular, a high hardness. The main body material may be, for example, a metal compound or pure metal, for example a metallic alloy, a steel, brass, copper and/or aluminum. The main body material may be a combination of said materials. According to the invention, the magnetic plastic part has a contact surface across which the magnetic plastic part is connected to the main body in a positionally fixed manner, so that at each location of the contact surface the magnetic plastic part is connected in a positionally fixed manner to a corresponding location of the main body. Particularly preferably, the magnetic plastic part is in direct contact with the main body with its contact surface. The magnetic plastic part can, for example, be molded directly to the main body or, for example, bonded to the main body over the contact surface. Injection molding of the plastic part to the main body is particularly advantageous for simple and inexpensive production of the magnetic component while ensuring a positionally fixed assignment of each location of the contact surface of the plastic part to a corresponding location of the main body. According to the invention, the compound comprises at least 60% by weight, in particular at least 70% by weight, in particular at least 80% by weight, in particular between 60% by weight and 95% by weight, in particular between 70% by weight and 95% by weight, in particular between 80% by weight and 95% by weight, of the magnetic particles and is designed as an elastic material for avoiding crack formation in the magnetic plastic part. An elastic material is a material which exhibits reversible deformability within a range of elongation in an operating temperature range. Particularly preferably, the elastic material exhibits viscoelastic deformation behavior which can be described, at least approximately, as elastic deformation behavior within the elongation range. The magnetic particles are in particular hard magnetic particles, especially preferably ferrites, neodymium-containing particles, for example NdFeB, and/or for example SmCo, although, in particular, different magnetic particles can be contained in the compound. Particularly preferred, at least 80% by weight, especially at least 90% by weight of the magnetic particles are ferrites. The magnetic particles are not compatible with the polymeric matrix formed by the support material, but are coupled to the matrix of the polymeric support material in the compound, for example by means of coupling agents. For example, silanes, titanates, zirconates and maleic anhydride-grafted polyolefins may be used as coupling agents. The use of adhesion promoters and the selection of suitable adhesion promoters, such as from the indicated adhesion promoters, is within the scope of skilled practice of a person skilled in the art for the production of magnetic compounds, wherein, according to the invention, the compound preferably comprises from 0.1% to 3% by weight, in particular from 0.1% to 1% by weight, of such adhesion promoters.

According to the invention, the compound is designed as an elastic material so that crack formation in the magnetic plastic part is avoided. It should be taken into account that, according to the invention, the magnetic plastic part is fixed in position to the main body over the contact surface so that stresses can occur in the plastic part because of this fixed position across the contact surface. It should be noted at this point that in general the magnetic plastic part is preferably connected to the main body exclusively across the contact surface in order to fix the position of the plastic part relative to the main body. Stresses in the plastic part can occur, for example, due to the different thermal expansion behavior of the main body material and the compound, in particular when the temperature of the magnetic component changes, i.e. when the magnetic component is exposed to different temperatures, as is usually the case in the intended use of the magnetic component according to the invention. In particular, the compound, with the exception of the magnetic particles contained in the compound, is meltable, such that preferably all the constituents of the compound, with the exception of said magnetic particles, are flowable at a respective temperature below the decomposition temperature of the polymeric support material. The polymeric support material is preferably a thermoplastic. In particular, all of the components, with the exception of the magnetic particles, are flowable within a preferably common temperature range, said temperature range preferably being below 300° C. and above 50° C. Preferably, the compound is fusible at a temperature below the decomposition temperature of the polymeric support material to form a homogeneously flowable mass in which the magnetic particles are the only inhomogeneities. Preferably, the magnetic particles are the only solid particles embedded in the flowable mass and having a particle size of more than 0.5 µm. This means that preferably only the magnetic particles are present in a solid aggregate state at the temperature at which the compound is melted to form a homogeneously flowable mass, and in particular all the constituents of the compound, with the exception of the said magnetic particles, are present in their liquid aggregate state. In general, within the meaning of the invention, a thermoelastic aggregate state that may be present, for example, in the case of semicrystalline thermoplastics at room temperature, is also understood to be a solid aggregate state, and a thermoplastic aggregate state is understood to be a liquid aggregate state. Thus, the compound can preferably be melted at a temperature below the decomposition temperature of the polymeric support material to form a homogeneously flowable mass in such a way that the magnetic particles are the only particles formed as solids embedded in the flowable mass and having a particle size of more than 0.5 µm. This allows for improved processing and easier recycling of the magnetic component. Preferably, the compound is processed into the magnetic plastic part by a processing method, in particular injection molding, in that in a first working step the compound is applied to the main body as a homogeneously melted mass in which the magnetic particles are embedded as the only inhomogeneities, and in a second working step is cooled at the main body and in the process solidifies at the latter, forming a rotationally fixed connection with the main body. Particularly preferably, the magnetic plastic part, i.e., the elastic property of the compound from which the magnetic plastic part is made, is designed in such a way that, in the event of temperature changes of the magnetic component over a temperature range from -10° C. to +100° C., in particular from -30° C. to +120° C., preferably from -40° C. to 125° C., material stresses which occur in the magnetic component due to the different thermal expansion behavior of the main body and plastic part are absorbed elastically in the compound and thus in the magnetic plastic part, while avoiding crack formation. In particular, the stiffness, preferably expressed by the tensile modulus of elasticity, of the main body is greater than the stiffness of the plastic part. At the same time, of course, the magnetic plastic part is always connected to the main body in a positionally fixed manner across the contact surface during the temperature changes of the magnetic component. Preferably, a stiffness of the compound, which is expressed in particular by means of the tensile modulus, is increased compared to a stiffness of the polymeric support material, which is expressed in particular by means of the tensile modulus of elasticity, by embedding the magnetic particles. In particular, at least 70% by weight, in particular at least 85% by weight, in particular at least 95% by weight, in particular at least 99% by weight of the polymeric support material consists of uncrosslinked polymeric material. The skilled person understands by an uncrosslinked polymeric material that the molecules or macromolecules forming the material are not crosslinked with each other or are crosslinked only to a negligible extent by covalent bonds. Preferably, the magnetic plastic part is made of a compound in which the constituents of the compound, and thus the magnetic particles and the polymeric support material, are homogeneously distributed so that the plastic part has a homogeneous distribution of the constituents throughout its volume. Particularly preferably, the magnetic plastic part is made from a compound consisting of polymeric support material and the magnetic particles, the magnetic particles being embedded in the polymeric support material and the polymeric support material extending as a homogeneous material between the magnetic particles. The mechanical properties of the compound therefore preferably result from the mechanical properties of the polymeric support material and its interaction with the magnetic particles, and material transitions within the polymeric support material are negligible for the mechanical properties of the compound. In particular, the polymeric support material is formed as a homogeneous material in such a way that it has at most material transitions which can be determined as defined below and which are considered negligible for the mechanical properties of the compound. Preferably, the support material extending between the magnetic particles is homogeneous in such a way that in a random determination of ten spaced-apart cube-shaped test volumes of 1 mm³ each in the total volume of the plastic part in which in each case two square cross-sectional areas running perpendicular to one another and spaced apart from one another in each direction with a respective side length of 20 µm are arbitrarily selected within the test volume, i.e. freely selected within the test volume, in which in each case 25 square cross-sectional area regions of 4 µm² are defined, which are arranged statistically equally distributed over the respective cross-sectional area, in which in each case exactly one, in particular square, test area of 1 µm² is defined, at at least 90%, in particular at least 95%, in particular at least 98% of these test areas, in particular at each of these test areas, preferably with a normally distributed variance of less than 10%, in particular less than 5%, in particular less than 2%, about the expected value, in particular the arithmetic mean value, either no material transition or exclusively a material transition between the polymeric support material and at least one magnetic particle is detectable. The skilled person understands by the aforementioned material transition, of course, a transition between at least two different materials present at least in the magnetic plastic part in a solid aggregate state, i.e., as a solid body. A transition to an air or gas inclusion, blowhole, vacuole and the like is accordingly not to be understood as a material transition in the aforementioned sense. In particular, the aforementioned, preferably with a proportion as described above and/or with a variance as described above, can already be determined with a defined quantity of test areas from all of the test volumes that consist of twenty, in particular ten, in particular five, in particular two, of the test areas of each of the test volumes, wherein in each case half of the number of these test areas per test volume is assigned to one of the two cross-sectional areas of the test volume. The determination of the test volumes or the cross-sectional areas within the respective test volume is an imaginary determination by which a position of the respective test volume or the respective cross-sectional area or the respective test area within the overall volume of the plastic part is determined. Preferably, the plastic part is designed in such a way that even if the two cross-sectional surfaces perpendicular to one another are defined within each of the test volumes with the proviso that these cross-sectional surfaces are spaced apart from one another by at least 100 µm in all spatial directions, and/or with the proviso that the test volumes are distributed uniformly over the total volume or the volume range of the plastic part defined below, the above-mentioned conditions for the measured test surfaces are fulfilled. Preferably, the test volumes are to be taken exclusively within a volume range of the total volume that is at least 100 µm away from all absolute ends of the plastic part in order to exclude the influence of edge effects on the test volumes. This means that the compound is homogeneous in such a way that, as a rule, the material extending between the magnetic particles extends without any material transition between the magnetic particles, which can be detected, for example, by checking a sufficiently large amount of test volumes within the plastic part, in particular exclusively within the said volume range of the total volume of the plastic part, for example as described above. A material transition in a material volume is characterized by the fact that it defines a boundary between two partial volumes, i.e. between two solid partial volumes, of the material volume, which consist of different materials, wherein the materials may differ, for example, in their mechanical properties or in their chemical compositions, neglecting usual, unavoidable deviations from the mechanical properties or chemical compositions within a material known to the skilled person. Due to the fact that the polymeric support material is homogeneous between the magnetic particles, the compound can be realized with particularly good mechanical properties, in particular with a high modulus of elasticity of more than 9 GPa, in particular more than 10 GPa, and preferably simultaneously a tensile stress of 30 MPa to 100 MPa, in particular 35 MPa to 95 MPa, and preferably simultaneously an elongation at break of 1% to 6%. In this case, preferably due to the high modulus of elasticity, a certain approximation to the stiffness or hardness of the main body can be achieved and at the same time a sufficient elastic property can be ensured, which is particularly advantageous overall for the mechanical properties and the load capacity of the magnet component in typical applications. The inventors have recognized that different from, e.g., compounds known in the prior art, in which the polymeric support material extending between the magnetic particles comprises an amount of rubber-elastic particles that has a relevant influence on the elastic properties of the compound, which is associated with material transitions within the polymeric support material extending between the magnetic particles, the magnetic properties of the compound of the plastic part according to the invention, in particular the durability of the magnetic component according to the invention as a whole, can thereby be significantly improved. Preferably, the polymeric support material has a proportion of less than 5% by volume, in particular less than 1% by volume, in particular less than 0.5% by volume of elastic particles and/or other particles, in particular no elastic particles and/or other particles at all, so that the homogeneous property mentioned can be realized. The inventors have thus recognized that it is particularly advantageous to realize the mechanical properties without relevant use of such particles in the polymeric support material, where possibly a negligible proportion of such particles can still be tolerated without detrimental influence on the mechanical properties of the compound.

Particularly preferably, the compound consists for at least 84% by weight of magnetic particles. Preferably, the compound contains between 84% by weight and 92% by weight of magnetic particles, the percentage of magnetic particles being focused on the ratio of the weight of the magnetic particles relative to the weight of the compound containing the magnetic particles. Preferably, the polymeric support material comprising the compound comprises at least one polyamide, wherein the polymeric support material may in particular comprise more than one polyamide. Preferably, the residual portion of the compound not formed by the magnetic particles comprises at least 50% polyamide, in particular at least 70% polyamide, in particular at least 80% polyamide. In particular, the compound has a modulus of elasticity of 10 GPa to 25 GPa. The compound is preferably such that the main body material and the compound have different thermal expansion behavior. The different thermal expansion behavior is shown in particular by the fact that the main body material has a lower linear thermal expansion coefficient than the compound. In particular, the main body material exhibits an isotropic thermal expansion behavior, whereby a test specimen made of the main body material when tested with respect to its thermal expansion behavior exhibits a similar, in particular an identical linear thermal expansion coefficient in each direction. Particularly preferably, the compound exhibits a similar linear thermal expansion coefficient in each spatial direction, in particular the same linear thermal expansion coefficient. Preferably, when the compound has a temperature that is below a glass transition temperature of the polymeric support material, the compound has a different linear thermal expansion coefficient than when it has a temperature that is above the glass transition temperature. In particular, the linear thermal expansion coefficient of the compound at a temperature above the glass transition temperature is greater than the linear thermal expansion coefficient at a temperature below the glass transition temperature. Preferably, the linear thermal expansion coefficient of the compound at a temperature range below the glass transition temperature is at least twice as large as the linear thermal expansion coefficient of the main body at the same temperature range. Preferably, this temperature range is defined by the limiting temperature values of -40° C. and 5° C. below glass transition temperature. Particularly preferably, the linear thermal expansion coefficient of the compound at a temperature range above the glass transition temperature is at least twice as large, in particular more than twice as large, as the linear thermal expansion coefficient of the main body at the same temperature range. Preferably, this temperature range is defined by the limiting temperature values of 5° C. above glass transition temperature and 125° C. In particular, the main body material has a linear thermal expansion coefficient in a range from 15*10⁻⁶ 1/K to 25*10⁻⁶ 1/K. In particular, the linear thermal expansion coefficient of the compound at a temperature above the glass transition temperature is at least 1.5 times as large, in particular at least as 2 times as large, as the linear thermal expansion coefficient at a temperature below the glass transition temperature. The determination of the linear thermal expansion coefficient shall generally be based on a measurement in accordance with the requirements of ISO 11359-1/-2. When determining the linear thermal expansion coefficient, a cuboid specimen made of the compound with side lengths of 3 mm x 3 mm x 4 mm, loaded with less than 1 N and subjected to a temperature change of 10 K per minute, shall be used for the measurement. The ratio of the linear thermal expansion coefficients of the main body material and the compound is to be formed from average values, should different, in particular direction-dependent expansion coefficients be determinable for the respective material.

Unexpectedly, the inventor has been able to determine that the compound with the above-mentioned properties is particularly robust to temperature influences and is thus particularly well suited as a material for the magnetic plastic part. Crack formation due to repeated temperature changes can be avoided particularly well if the main body material in turn has a thermal expansion behavior which corresponds in the above-mentioned manner to the thermal expansion behavior of the compound. The ratio of the linear thermal expansion coefficients makes it possible, on the one hand, for the different thermal expansion behavior not to lead to failure of the magnetic component and, on the other hand, for the main body and magnetic plastic component not to become detached from their connection to one another and become movable relative to one another. Providing a high proportion of magnetic particles also allows a magnetic component to be provided which has a high flux density. Providing a high proportion of magnetic particles is typically associated with embrittlement, i.e. low tensile strength and high modulus of elasticity, of a material in which the magnetic particles are embedded. However, the inventor has been able to determine that the compound with the above-mentioned properties does not have exactly such disadvantages and can meet the requirements for mechanical properties. At the same time, the inventor has succeeded in ensuring, through the above-mentioned combination of properties, that the main body maintains a particularly secure and positionally stable connection with the magnetic plastic part. Despite a high proportion of magnetic particles, the above properties make it possible to provide a high mechanical and thermal load-bearing capacity of the magnetic component, which benefits a long service life of the magnetic component according to the invention.

Particularly preferably, the compound has such elastic properties that corresponding crack formations are avoided when the magnet component is exposed in each case to one of the limit temperatures of the ranges indicated above for at least 20 minutes and is subsequently exposed to the other indicated limit temperature of the range for at least 20 minutes, so that the entire magnet component has in each case approached the respective limit temperature as far as possible after the expiry of the at least 20 minutes, wherein the change from the one limit temperature to the other limit temperature is effected within ten seconds, wherein, particularly preferably, crack formations are also avoided if, as explained, there is a cyclic back and forth change between the limit temperatures of the corresponding range over a total of 500 cycles, in particular over a total of 1000 cycles, in particular over a total of 1500 cycles.

The magnetic component according to the invention brings a number of advantages compared with conventional magnetic components. Due to the fact that the magnetic component comprises a main body and a magnetic plastic part that is made of an elastic compound and is fixed in position on the main body across the contact surface, a robust magnetic component can be provided in a very simple manner. For one thing, there is no longer any need to provide an intermediate layer in the magnetic component between the main body and the magnetic plastic part, which both complicates the manufacture of the magnetic component and can have negative influences on the stability of the magnetic component. Instead, the elastic design of the plastic part enables the plastic part itself to elastically absorb and relieve stresses that arise between the main body and the magnetic plastic part, which reliably prevents cracks from forming in the magnetic plastic part. In this context, the inventor has surprisingly found that such an elastic magnetic plastic part can also have a very high proportion of magnetic particles, so that a magnetic field required for the application purposes can be provided with this magnetic plastic part. In addition, the elastic magnetic plastic part can be easily fixed to the main body in a positionally fixed manner. For example, the plastic part can be connected to the main body in a force-fit manner and thus with static friction, for example by injection molding the plastic part to the main body and allowing it to shrink and bond to the main body during cooling after injection molding. Particularly preferably, a form fit can also be provided between the plastic part and the main body part. Particularly preferably, the form fit is designed in such a way that of the two components of the magnetic component, namely the main body and the magnetic plastic part, at least one has recesses in which the other component engages, preferably these recesses having an outer contour with which the recesses bear against the other component, which have a rounded progression and thus have no sharp edges, preferably avoiding angles of 90° in their progression, so that problematic material stresses can be prevented. The recesses can be designed, for example, as notches and/or holes. Particularly preferably, the main body is designed as a sleeve, shaft or disk, the main body being assigned an axis of rotation about which it is to be rotated when it is attached as intended to a component to be rotated. For example, the main body can be designed symmetrically to this axis of rotation assigned to it. Particularly preferably, the progression of the recesses about this axis of rotation has an outer contour which is rounded and in particular does not have 90° angles, in particular only has angles of > 90°.

The essential finding of the invention is based on the fact that it is particularly advantageous in the case of the magnetic component to provide an elastic magnetic plastic part which is correspondingly made of an elastic magnetic compound. Whereas in the prior art it is conventionally assumed that, in order to bond a magnetic plastic part to a main body which is essentially inelastic and serves the intended purpose described, either a very complex design of the magnetic component or, preferably, the provision of an elastic intermediate layer between the main body and the plastic component is required because of the material properties of the plastic part predetermined by the magnetic particles, the invention takes a different approach in that the plastic part itself is made from an elastic compound. It has been found to be particularly advantageous that the compound has a tensile stress of from 30 MPa to 100 MPa, in particular from 40 MPa to 90 MPa, and/or has an elongation at break ranging from 1% to 6%, in particular from 1.5% to 5%, and/or preferably has a tensile modulus of elasticity ranging from 7 GPa to 30 GPa, in particular from 10 GPa to 25 GPa. This is based on values obtained by measuring the said values in accordance with DIN ISO 527-1/-2. A test speed of 5 mm per minute is provided for the standardized determination of the above values by means of a tensile test in a standard climate. The modulus of elasticity is determined in an elongation range of 0.005% to 0.025. By standard climate is meant an ambient temperature of 23° C. and a relative humidity of the ambient air of 50%, where a test specimen to be measured must be exposed to the standard climate for a period of at least 16 hours prior to measurement. In general, references to standards always refer to the version of the standard valid at the time of application. Particularly preferably, the compound and thus the plastic part has a tensile modulus of elasticity which is less than half, in particular less than one third, in particular less than one fifth, in particular less than one tenth of the tensile modulus of elasticity of the main body material and thus of the main body. The modulus of elasticity of the main body material is to be determined by applying the standard for the tensile test applicable to the respective material class to which the main body material belongs, for example DIN EN ISO 6892-1 for metal or DIN EN ISO 527-4/-5 for fiber-reinforced plastics, wherein in the case of fiber-reinforced plastics the maximum modulus of elasticity in the fiber direction is to be taken into account. The selection of the constituents which are mixed with one another during compounding to produce the compound to obtain a compound with the stated values has proved to be particularly advantageous, since the compound then enables the production of a magnetic plastic part which, as stated, avoids crack formation particularly effectively and additionally has a sufficient proportion of magnetic particles and sufficient robustness so that it can be reliably fixed in position at the main body. By providing the indicated ratios of the tensile moduli of the plastic component and the main body, such crack formation can be avoided in a surprisingly simple manner, while the two components of the magnetic component have material properties particularly suitable for their respective purposes. Furthermore, it has been surprisingly disclosed to the inventor that the compound with properties according to the indicated values can preferably be applied directly to the main body, preferably by means of injection molding, whereby the magnetic plastic part with the desired geometry can be produced and simultaneously joined to the main body. This can make it possible to dispense with intermediate steps in production, such as the production of a magnetic plastic part and the subsequent application of the magnetic plastic part to the main body in a separate assembly step, and to make production more efficient.

It has been found to be particularly advantageous to provide a semi-crystalline thermoplastic as the polymeric support material. Particularly preferably, the polymeric support material consists of at least 80% by weight of, for example, semi-crystalline thermoplastics polyethylene (PE), polypropylene (PP), thermoplastic elastomers (TPE), polyamide (PA), polybutylene terephthalate (PBT), polyphenylene sulfide (PPS) or the like. Particularly preferably, at least 80% by weight of the polymeric substrate consist of a polyester and/or at least one polyamide. Because of the lower viscosity, it has been found to be particularly advantageous that the polymeric support material consists for at least 50% by weight, in particular at least 80% by weight, of at least one aliphatic polyamide. In general, the polymeric support material is preferably made for more than 80% by weight from a semi-crystalline thermoplastic and is characterized by particularly high temperature resistance, so that the compound can be used permanently at an ambient temperature of 125° C. It has been found to be particularly advantageous to provide a blend comprising different polymers, in particular different polyamides, as the polymeric support material. For example, it has been found to be particularly advantageous to produce the polymeric support material by blending different polyamides, in particular aliphatic polyamides. In general, it has been found to be particularly advantageous to produce the compound in such a way that at least 5% by weight, in particular at least 8% by weight, in particular between 5% by weight and 20% by weight, in particular between 8% by weight and 16% by weight, of the compound from which the magnetic plastic part is produced consists of polymer. Particularly preferably, further additives are added during compounding to produce the compound, in particular adhesion promoters, lubricants and/or a thermo-stabilizer, wherein particularly preferably the compound and thus the magnetic plastic part consists for 0.05% by weight to 2% by weight, in particular 0.1% by weight to 1% by weight, in particular 0.2% by weight to 0.8% by weight of an adhesion promoter and/or for 0.1 % by weight to 5% by weight, in particular 0.1% by weight to 3% by weight of lubricants and/or for 0.02% by weight to 2% by weight, in particular 0.03% by weight to 1% by weight of thermo-stabilizers, and/or 0.5% by weight to 5% by weight of impact modifiers. Common adhesion promoters, lubricants, thermo-stabilizers and impact modifiers are known to a person skilled in the art, i.e. a specialist in plastics processing, and the addition of corresponding additives during compounding to produce a compound is common in the prior art. For example, silanes, titanates, zirconates, maleic anhydride grafted polyolefins can be used as coupling agents, and alcohols, for example, esters, fatty acids, waxes, stearates and metal soaps can be used as lubricants. Sterically hindered phenols, benzoates, amides and metal salts, for example, can be used as thermo-stabilizers, such thermo-stabilizers basically serving the purpose of acting as radical scavengers to scavenge radicals that may be released, for example, due to elevated heat, in order to counteract chain degradation of the polymer and thus embrittlement of the polymer and thus of the compound. Impact modifiers are typically low molecular weight substances or polymers which have a lower melting point than the polymeric matrix material of the compound by which the polymeric matrix of the polymeric support material is formed and which occupies more than 80% by weight of the polymeric support material.

The inventor has thus recognized that, unexpectedly, conventional compounding processes in which additives are used, in particular in the ranges indicated, can easily produce an elastic compound with the magnetic properties described, by means of which, as explained, cracking and thus damage to the magnetic component can be prevented. It has proved particularly advantageous to use magnetic particles in the compound which have an average particle size of 0.5 µm to 100 µm, in particular of 0.5 µm and 5 µm, in particular of 1 µm to 5 µm, in particular of 1 µm to 3 µm. It has proved particularly advantageous to use ferritic particles as magnetic particles, which have a particle size of 0.5 µm and 5 µm, in particular from 1 µm to 5 µm, especially from 1 µm to 3 µm. The corresponding particle size is particularly advantageous for the properties, in particular elastic properties, of the compound in combination with the specified percentage of magnetic particles in the compound. The indication of the particle size can refer in particular to the determination by means of optical measuring methods, in particular by means of transmitted light microscopy. It has generally proved particularly advantageous to produce the compound in such a way that it has a melt mass flow rate, also known to those skilled in the art as MFI (melt flow index) or MFR (melt flow rate), of between 30 g per 10 minutes and 150 g per 10 minutes, based on a measurement according to DIN ISO 1133A, in which a sample mass is melted at 270° C. and, loaded with a weight of 10 kg, pressed through a standardized capillary. It has also been found to be generally advantageous to produce the compound at a density such that the density is between 2.0 g/cm³ and 5.0 g/cm³, in particular between 3.0 g/cm³ and 4.0 g/cm³, based on a measurement of the density according to DIN EN ISO 1183, particularly preferably on a measurement of the density according to DIN EN ISO 1183-2. It is to be taken into account that the provision of a corresponding density is apparent to the person skilled in the art from the context of the use of corresponding polymers and corresponding magnetic particles, the inventor having found that, with the corresponding ratios between magnetic particles, polymers and further additives, particularly advantageous properties of the compound result when the specified density of the compound is achieved.

The invention further relates to the use of a main body, magnetic particles and a polymer powder for realizing a magnetic component, in particular a magnetic component according to the invention as explained above. The invention further relates to a method for producing a magnetic component, in particular a magnetic component according to the invention. The polymer powder comprises one or more polymers in granular or powder form, and the additives to be added in addition to the magnetic particles. According to one aspect of the invention, an elastic compound is produced comprising at least 60% by weight of the magnetic particles and at most 40% by weight of the polymer resulting from the polymer powder, wherein the compound, in particular the molten compound obtained by melting, is applied to the main body, in particular directly to the main body, and is attached thereto, in particular exclusively by the direct application, for example, by applying the compound to the main body as part of an injection molding process and subsequent cooling to achieve shrink-fitting of the compound to the main body, in particular by producing an interference fit, by forming static friction between the compound and the main body and/or by producing a form fit by applying the compound to the main body that has corresponding recesses for this purpose. In the preferred embodiment, no further fixing means, such as intermediate layers, in particular adhesive layers, are thus provided.

In further advantageous embodiments, polyamide may be provided instead of polyester. It has generally been found to be advantageous to use at least predominantly polyamide as the polymer when the proportion of magnetic particles in the plastic part is more than 80% by weight.

The invention further relates to a process for producing a resilient magnetic compound, wherein magnetic particles are mixed with a polymer powder to produce the compound in such a ratio that, in the compound produced, the magnetic particles constitute at least 60% by weight of the compound and the polymers resulting from the polymer powder constitute at most 40% by weight of the compound. The use according to the invention and the methods according to the invention may be combined with each other and may each and in their combination have features which are apparent to the skilled person in connection with the above explanations of a magnetic component according to the invention. Similarly, the magnetic component according to the invention may have features which are apparent to the person skilled in the art from the present description of a use according to the invention and a method according to the invention and the respective preferred embodiments. It should also be noted at this point that the magnetic component according to the invention, the method according to the invention and the use according to the invention may each have features which are apparent from the above description of generic magnetic components.

Particularly preferably, in the use according to the invention or the process according to the invention, the polymer powder is mixed with the magnetic particles during the creation of the compound and is subsequently melted. Preferably, the polymer powder is melted first, after which the magnetic particles are added to the melted polymer powder and mixed with the melted polymer powder. Particularly preferably, in the use or process according to the invention, the polymer powder is melted first, after which adhesion promoters, lubricants, thermal stabilizers and/or impact modifiers are then added to the melted polymer powder and mixed with the melted polymer powder. In the mixing, of course, uniform mixing is preferred, where uniform mixing means in particular homogeneous distribution of the fillers and additives in the molten polymer powder. Preferably, the compound is produced by an extrusion process, in particular using a preferably co-rotating twin-screw extruder. The skilled person is qualified by his knowledge to provide suitable degassing zones when using the extrusion process, to use different screw geometries and/or to provide different tempering zones, which he knows how to scale and adapt to the extruder used in favor of gentle processing. Particularly preferably, the magnetic particles are added to the molten polymer powder only after at least impact modifiers have been added to the molten polymer powder. The inventor has found that the material quality of the compound can be particularly improved if the magnetic particles are added only after the polymer powder has been melted, and in particular only after the impact modifiers have been added, in order to avoid undesirable dissipation-induced reduction in intrinsic viscosity, or molecular weight, and/or quality-reducing chemical reactions between the magnetic particles and corresponding additives. Particularly preferably, the magnetic particles are added to the molten polymer powder only after all additives have been previously added to the molten polymer powder. In general, it is particularly preferred to use a polymer powder comprising different polymers, in particular, as explained above with reference to the magnetic component, different polyamides. It has been found to be particularly advantageous to produce the compound by using a polymeric support material whose density is between 1.0 g/cm³ and 1.3 g/cm³ and whose melt mass flow rate is between 50 g / 10 min and 200 g / 10 min (melting temperature 270° C., 10 kg bearing load according to DIN ISO 1133A) and whose tensile modulus of elasticity is between 1.0 GPa and 4.0 GPa and whose elongation at break is 10% by weight to 60% by weight. In this context, the polymeric support material can in particular be selectively produced first without the addition of magnetic particles and adapted to achieve the stated properties, after which the compound is subsequently produced by using the constituents of the polymeric support material which are required to achieve the stated properties of the polymeric support material on their own as a polymeric plastic and mixing them with the magnetic particles in the stated advantageous proportions, whereby a compound with the stated particularly advantageous properties can be produced. In particular, the compound can be made without the intermediate step of making the polymeric support material, and in particular the components of the polymeric support material are to be mixed into the compound in the same proportions relative to each other as they are mixed into the polymeric support material.

Preferably, the magnetic plastic part is produced by a processing method, in particular injection molding method, in that in a first working step the compound is applied to the main body as a homogeneously melted mass in which the magnetic particles are embedded as the only inhomogeneities and/or in which the magnetic particles are the only particles formed as solids embedded in a flowable mass and having a particle size of more than 0.5 µm, and in a second working step is cooled on the main body and solidifies on the latter while forming a rotationally fixed connection with the main body. Particularly preferably, the magnetic plastic part is produced by means of injection molding. Particularly preferably, the distribution of the magnetic particles in the plastic part is homogeneous in such a way that a first volume unit can be defined in the plastic part, which lies directly against the main body, and a second volume unit can be defined, the volume of which is identical to the volume of the first volume unit, the second volume unit being arranged on the side of the first volume unit facing away from the main body and the proportion of magnetic particles (in % by weight) in the first volume unit differing by less than 30%, in particular by less than 20%, from the proportion in the second volume unit, the percentage deviation being based on the proportion in the first volume unit, in particular the volume in each case being at least 1 mm³, in particular 3 mm³. Particularly preferably, the magnetic plastic part is manufactured by means of injection molding and is thereby directly molded to the main body during its manufacturing process. Particularly preferably, the main body and the plastic part molded to the main body are designed in relation to one another in such a way that the plastic part is connected to the main body across its contact surface in static friction contact and/or is connected to the main body in a positive-locking manner. Particularly preferably, the magnetic plastic part is produced by being molded to the main body circumferentially around the main body or by being molded to a circumferential inner side of the main body from the inside, the circumferential inner side of the main body circumferentially enclosing a cavity enclosed by the main body. Particularly preferably, the main body is assigned an axis of rotation, the magnetic plastic part being molded to the main body circumferentially around the axis of rotation, either to an outer side of the main body facing away from the axis of rotation, circumferentially closed or segmented around the axis of rotation, or to an inner side of the main body facing the axis of rotation, circumferentially closed or segmented around the axis of rotation. For this purpose and generally preferably, the main body is made of a metal compound, in particular exclusively of metal, and preferably has the shape of a shaft or a sleeve or a circular disc.

The invention is explained in more detail below with reference to six figures by way of examples of embodiments.

In the drawings it is shown by:

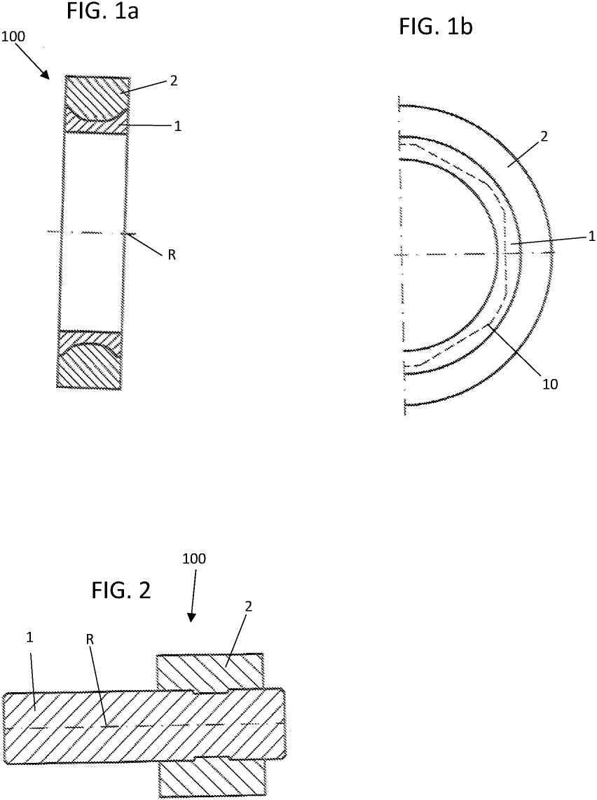

FIG. 1: various views of one embodiment of a magnetic component according to the invention in schematic representations;

FIG. 2: a view of a further embodiment of a magnetic component according to the invention in a schematic representation;

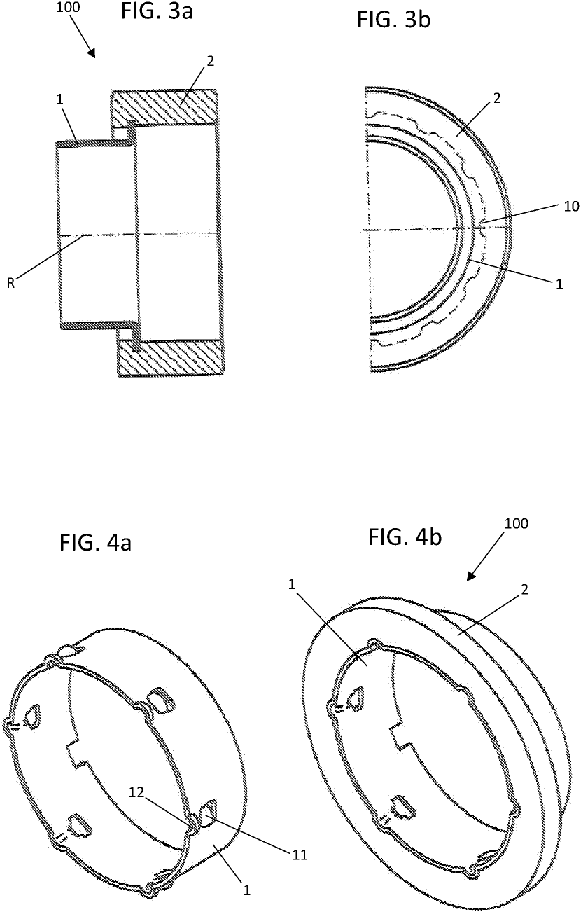

FIG. 3: a further embodiment of a magnetic component according to the invention in schematic representations;

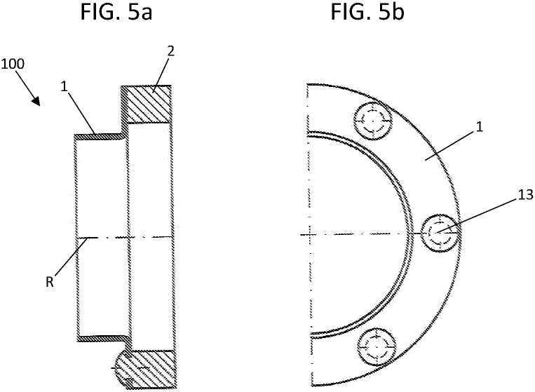

FIG. 4: a further embodiment of a magnetic component according to the invention in schematic representations;

FIG. 5: a further embodiment of a magnetic component according to the invention in schematic representations.

FIG. 1, comprising FIGS. 1a and 1b, shows one embodiment of a magnetic component according to the invention in schematic representations. FIG. 1a shows a view of a cross-section of the magnetic component 100, FIG. 1b shows a schematic top view of the magnetic component 100. The magnetic component 100 has a main body 1 and a magnetic plastic part 2. The main body 1 is designed as a sleeve and has a recess in which the plastic part 2 is embedded. The plastic part 2 is produced by injection molding to the sleeve 1. The recess of the sleeve 1, in which the plastic part 2 engages, has the flats 10 shown schematically in FIG. 1b, which are formed by the outer contour of the recess and which ensure an improved form fit between the plastic part 2 and the main body 1. In FIG. 1a, the axis of rotation R associated with the main body 1 and thus with the magnetic component 100 is schematically drawn. From the combined view of FIG. 1a and FIG. 1b, with FIG. 1b showing a schematic top view of the magnetic component 100 along the axis of rotation R, it is apparent that there is a particularly advantageous form fit between the magnetic plastic part 2 and the sleeve 1, which effectively counteracts relative movement of the plastic part 2 and the sleeve 1 both along the axis of rotation R and perpendicular to the axis of rotation R, in particular also a rotation of the plastic part 2 relative to the sleeve 1 about the axis of rotation R, since the flats 10, which are formed by the outer contour of the recess of the sleeve 1, do not extend rotationally symmetrically about the axis of rotation R in a plane perpendicular to the axis of rotation R. In the described embodiment, the magnetic plastic part 2 comprises 90% by weight of ferritic hard magnetic particles having an average particle size of 1.5 µm. The magnetic plastic part 2 further consists of 9% by weight of a polymer, which in the present case is formed by different polyamides, as well as 0.1% by weight of an adhesion promoter, 0.2% by weight of lubricant, 0.1% by weight of a thermo-stabilizer and 0.6% by weight of an impact modifier. As is generally advantageous, the impact modifier is a polymer that has been functionalized with maleic anhydride and thus interacts with the polymer of the polymeric support material only via a secondary valency bond. In the present case, a phthalate is used as the impact modifier, although, as is familiar to those skilled in the art, substances based on, for example, adipates or ionomers can also be used as impact modifiers.

In FIG. 2, a further embodiment of a magnetic component 100 according to the invention is shown in a schematic representation. In this embodiment, the main body 1 is formed as a metallic shaft with a recess in which the plastic part 2 engages. Both the main body 1 and the magnetic plastic part 2 are each rotationally symmetrical about an axis of rotation R shown schematically in FIG. 2, which is generally advantageous according to the invention. As explained for FIG. 1, the magnetic plastic part 2 in FIG. 2 is also injection-molded onto the outside of the main body 1 around the axis of rotation R. In preferred embodiments, in the example according to FIG. 2, corresponding flats 10 as shown in FIG. 1 can also be provided in the recess of the main body 1 formed as a shaft. The plastic part 2 is produced by injection molding from a compound consisting of 71.5% by weight of magnetic particles, presently ferrites, 18% by weight of a polymer, presently polyester, and 2% by weight of an adhesion promoter, 3% by weight of a lubricant, 2.5% by weight of an impact modifier and 3% by weight of a thermo-stabilizer. In the embodiment described in FIG. 2, a silane is used as adhesion promoter, a fatty acid is used as lubricant, an adipate is used as impact modifier, and a phenol is used as thermo-stabilizer.

FIGS. 3 to 5 show further embodiments of the magnetic component 100 according to the invention in schematic diagrams. In these embodiments, the main body 1 is respectively made of metal, in this case steel, and the magnetic plastic part 2 is made of a compound as explained in the embodiment in FIG. 1. The magnetic plastic part 2 is always manufactured by injection molding and is molded directly to the main body 1 on the outside and/or inside circumferentially around the axis of rotation R during the manufacturing process. The various embodiments differ only with respect to the geometry and arrangement of the main body 1 and plastic part 2 and the resulting position of the plastic part 2 relative to the main body 1. In the embodiment according to FIG. 3, comprising FIGS. 3a and 3b, the plastic part 2 is injection-molded to a flange of the main body 1 that is designed as a sleeve, the flange forming flats 10 in which recesses are provided, so that a particularly robust, positionally fixed fixing of the plastic part 2 relative to the sleeve 1 is possible. In the embodiment according to FIG. 4, comprising FIGS. 4a and 4b, the main body 1 is designed as a sleeve which has, on the one hand, outward bends 12 and, on the other hand, recesses 11 with tabs. The plastic part 2 is molded around the outside of the main body 1 in such a way that it accommodates the outward bends 12 and engages in the recesses 11, thus ensuring a particularly reliable positionally stable fixing of the plastic part 2 relative to the main body 1. In the embodiment according to FIG. 5, comprising FIGS. 5a and 5b, the main body 1 is formed as a sleeve which has a flange, wherein circular recesses 13 are provided in the flange, wherein the plastic part 2 is injection-molded onto the flange in such a way that it engages in the circular recesses 13 for ensuring a particularly reliable fixation of the plastic part 2 relative to the main body 1.

### List of Reference Signs

1 main body

2 plastic part

10 flat

11 recess

12 bend

13 recess

100 magnetic component

R rotation axis

1. A magnetic component (100) comprising;
a main body (1) made of a main body material and
a magnetic plastic part (2) connected in a fixed position to the main body (1), the plastic part (2) being produced from a compound which includes a polymeric support material and magnetic particles embedded in the polymeric support material, and
wherein the main body material and the compound having different thermal expansion characteristics, and
the plastic part (2) has a contact surface by which it is connected in a positionally fixed manner to the main body (1), wherein at least 60% by weight of the compound consists of the magnetic particles and the compound is formed as an elastic material for preventing cracks from forming in the magnetic plastic part (2).

2. The magnetic Magnetic component (100) according to claim 1, one polyamide,
wherein the compound consists in particular of at least 84% by weight,
wherein the compound has a linear thermal expansion coefficient which is at least twice as large as that of the main body material, and herein in particular the compound has a modulus of elasticity which is in a range from 10 GPa to 25 GPa.

3. The magnetic Magnetic component (100) according to claim 1, wherein
the polymeric support material is a semi-crystalline thermoplastic, and
the polymeric support material consists at least 80% by weight of at least one polyester and/or at least one polyamide.

4. The magnetic Magnetic component (100) according to claim 1, wherein the magnetic particles have a mean particle size of 0.5 µm to 100 µm.

5. The magnetic Magnetic component (100) according to claim 1, wherein the compound has a melt mass flow rate between 30 g per 10 minutes and 150 g per 10 minutes.

6. The magnetic Magnetic component (100) according to claim 1, wherein the magnetic plastic component (2) is configured to elastically absorb material stresses which occur in the compound due to the different thermal expansion behavior of the main body (1) and plastic part (2) over a temperature range of -10° C. to 100° C. when the temperature of the magnetic component (100) changes, while avoiding crack formation.

7. The magnetic Magnetic component (100) according to claim 1, wherein the compound has a tensile modulus of elasticity of 7 GPa - 30 GPa and/or a tensile stress of 30 MPa - 100 MPa and/or an elongation at break of 1% to 6%.

8. The magnetic Magnetic component (100) according to claim 1, wherein the plastic part (2) is connected to the main body (1) by the contact surface in static frictional contact and/or is connected to the main body (1) in a form-fitting manner.

9. A method of manufacturing of the main body (1), magnetic particles and a polymer powder for realizing a magnetic component (100) according to claim 1, the method comprising
producing an elastic compound having at least 60% by weight of which consist of the magnetic particles and at most 40% by weight of polymer resulting from the polymer powder, and
applying the compound to the main body (1) and attaching the compound thereto.

10. The method according to claim 9, wherein during the production of the compound,
first melting the polymer powder,
then adding adhesion promoters, lubricants, thermo-stabilizers and/or impact modifiers to the melted polymer powder, and
adding the magnetic particles to the melted polymer powder.

11. The method according to claim 9, wherein producing the magnetic plastic part (2) by injection molding to the main body (1).

12. A method for producing an elastic magnetic compound for realizing a magnetic component according to claim 1, the method comprising:
mixing magnetic particles with a polymer powder in such a ratio that, in the compound produced, the magnetic particles constitute at least 60% by weight of the compound and the polymers resulting from the polymer powder constitute at most 40% by weight of the compound.

13. The method according to claim 9, wherein producing the magnetic plastic part is by injection molding.

14. The magnetic component (100) according to claim 1, wherein between 60% and 95% by weight, of the compound consists of the magnetic particles.

15. The magnetic component (100) according to claim 1, wherein the main body material is metallic.

16. The magnetic component (100) according to claim 1, wherein the main body material is metallic and the main body (1) is configured as a sleeve, a disc or a shaft.

17. The magnetic component (100) according to claim 1, wherein
the polymeric support material is a semi-crystalline thermoplastic,
the polymeric support material consists at least 80% by weight of at least one polyester and/or at least one polyamide including at least one aliphatic polyamide, and
wherein the polymeric support material is a blend comprising different polymers.

18. The magnetic component (100) according to claim 3, wherein the polymeric support material is a blend comprising different polymers.
